(19) United States
(12) Patent Application Publication
(10) Pub. No.: US 2010/0109904 A1
(43) Pub. Date: May 6, 2010

(54) SECURE REMOTE CONTROL APPARATUS AND METHOD

(75) Inventors: Deng-Huei HWANG, Danshui Town (TW); Ruey-Der LOU, Hsinchu City (TW); Tsang-Der NI, Hsinchu City (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: IMU SOLUTIONS, INC., Hsinchu City (TW)

(21) Appl. No.: 12/612,265

(22) Filed: Nov. 4, 2009

(30) Foreign Application Priority Data
Nov. 6, 2008 (TW) 097142962

(51) Int. Cl. G08C 19/00

(52) U.S. Cl. 340/825.69

(57) ABSTRACT

A secure remote control apparatus having a motion is provided. The secure remote control apparatus includes a determining device and a signaling unit. The determining device produces a first signal in response to the motion. The signaling unit transmits a plurality of signals associated with the first signal, wherein each of the plurality of signals has a respective transmitting direction. The secure remote control apparatus ensure that the receiver of the electronic apparatus controlled by the secure remote control apparatus still can receive a signal associated with at least one of the plural infrared signals when the secure remote control apparatus is waved.

### FIELD OF THE INVENTION

The present invention relates to a remote control apparatus and method, and more particularly to a secure remote control apparatus and method using motion driving.

### BACKGROUND OF THE INVENTION

At present, a remote controller for remotely controlling an electronic apparatus, e.g. a television, a set-top box, a digital video disk or a conditioner, and so forth, includes plural push buttons, a controller and an infrared transmitter. When detecting a push action happened on one of the plural push buttons, the controller determines a control code corresponding to the push action, and controls the infrared transmitter to transmit an infrared signal to the electronic apparatus, wherein the infrared signal includes the control code.

Since the micro-electro-mechanical component, e.g. the micro-electro-mechanical gyroscope, the accelerometer or the magnetometer/e-compass, and so forth, were available on the market, it has been found that the remote controller, or called the joystick, designed with these components, can be used to play interactive games, so that the design thereof becomes the focus in great attention. However, up to now, the design, people generally conceive, is that the electronic apparatus on the receiving terminal should be changed significantly. For instance, in the hardware aspect, the current infrared receiver is changed into a radio frequency receiver or a Bluetooth receiver; in the software aspect, the traditional simple user interface is changed into a complex graphic user interface. In this way, it is necessary to upgrade the processing unit and the operating system of the remote controller of this type.

Therefore, how to utilize the micro-electro-mechanical component for a remote control to remotely control an electronic apparatus becomes the demand on the market.

### SUMMARY OF THE INVENTION

It is an object of the present invention to transmit plural infrared signals having different directions in order to ensure that the infrared receiver of the electronic apparatus still can receive a signal associated with at least one of the plural infrared signals when the remote control apparatus is waved. Therefore, it is unnecessary to change the current infrared receiver into the radio frequency receiver or the Bluetooth receiver.

It is therefore an aspect of the present invention to provide a remote control apparatus having a motion. The remote control apparatus includes a determining device and a signaling unit. The determining device produces a first signal in response to the motion. The signaling unit transmits a plurality of signals associated with the first signal, wherein each of the plurality of signals has a respective transmitting direction.

It is therefore another aspect of the present invention to provide a secure remote controller including a determining device and a signaling unit. The determining device generates a message. The signaling unit transmits the message in a first direction and a second direction.

It is still another aspect of the present invention to provide a secure remote controlling method including the following steps. A controlling message is generated. The controlling message is transmitted in a first direction and a second direction.

### BRIEF DESCRIPTION OF THE DRAWINGS

The foregoing and other features and advantages of the present invention will be more clearly understood through the following descriptions with reference to the drawings, wherein:

FIG. 1 is a schematic diagram showing a remote control system according to the first embodiment of the present invention; and

FIG. 2 is a schematic diagram showing a remote control apparatus according to the second embodiment of the present invention.

### DETAIL DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

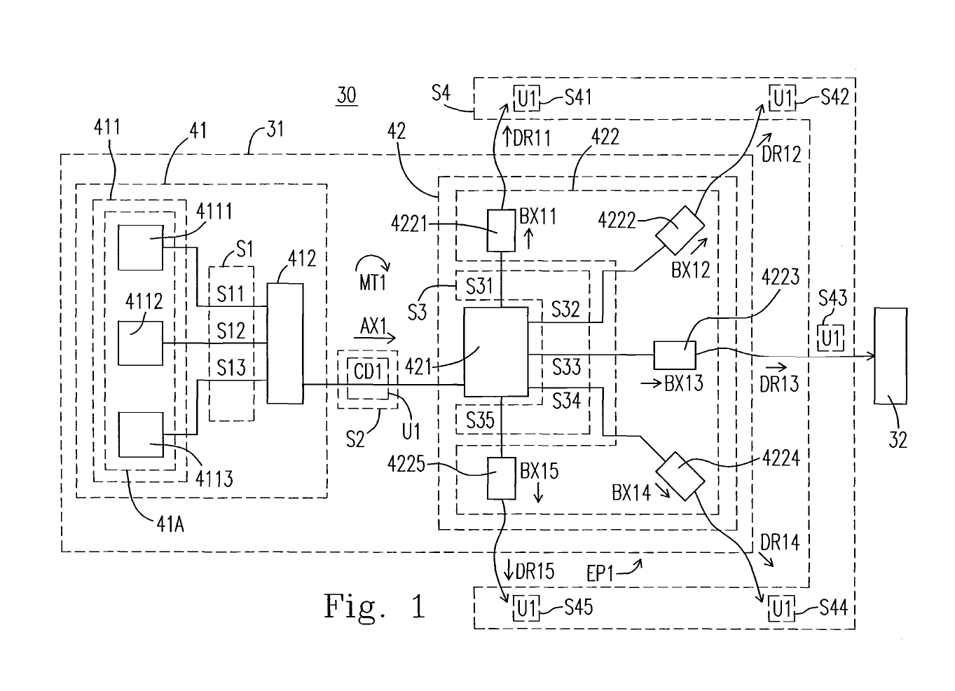

Please refer to FIG. 1, which is a schematic diagram showing the remote control system 30 according to the first embodiment of the present invention. As shown, the remote control system 30 includes the remote control apparatus 31 and the controlled apparatus 32 controlled by the remote control apparatus 31. The remote control apparatus 31 produces the signal S4 in response to the motion MT1. The signal S4 is transmitted with the plural transmitting directions DR11, DR12, DR13, DR14 and DR15. Therefore, the controlled apparatus 32 may receives a signal associated with the signal S4.

In an embodiment, the remote control apparatus 31 includes the determining device 41 and the signaling unit 42. The determining device 41 produces the signal S2 in response to the motion MT1. The signaling unit 42 transmits the plural signals S41, S42, S43, S44 and S45 associated with the signal S2, wherein each of the plural signals S41, S42, S43, S44 and S45 has a respective transmitting direction. For instance, the plural signals S41, S42, S43, S44 and S45 respectively have the plural transmitting directions DR11, DR12, DR13, DR14 and DR15.

In an embodiment, the remote control apparatus 31 has the motion MT1, and the signal S4 includes the plural signals S41, S42, S43, S44 and S45. In an embodiment, the signaling unit 42 transmits at least one selected from the plural signals S41, S42, S43, S44 and S45 associated with the signal S2.

The determining device 41 may include the sensing unit 411 and the processing unit 412. The sensing unit 411 senses the motion MT1 to produce the signal S1. The processing unit 412 produces the signal S2 in response to the signal S1.

In an embodiment, the sensing unit 411 includes the gyroscope 4111, the accelerometer 4112 and the magnetometer/e-compass 4113. The gyroscope 4111 has at least two sensing degrees of freedom and senses the motion MT1 for producing the first portion S11 of the signal S1. The accelerometer 4112 has at least two sensing degrees of freedom and senses the motion MT1 for producing the second portion S12 of the signal S1. The e-compass 4113 has at least two sensing degrees of freedom and senses the motion MT1 for producing the third portion S13 of the signal S1.

In an embodiment, the sensing unit 411 includes the first unit 41A. The first unit 41A includes at least one selected from a group consisting of the single gyroscope 4111, the accelerometer 4112 and the e-compass 4113. Additionally, the first unit 41A senses the motion MT1 for producing the signal S1.

The remote control apparatus 31 may has the reference axis AX1. The signaling unit 42 may include the driving circuit 421 and the signal module 422. The driving circuit 421 produces the driving signal S3 in response to the signal S2. The signal module 422 produces the signal S4 in response to the driving signal S3. The signal module 422 may include the plural signal transmitters 4221, 4222, 4223, 4224 and 4225.

The driving signal S3 includes the plural signals S31, S32, S33, S34 and S35. The plural signals S31, S32, S33, S34 and S35 are provided to the plural signal transmitters 4221, 4222, 4223, 4224 and 4225, respectively.

The plural signal transmitters 4221, 4222, 4223, 4224 and 4225 respectively have the plural principal directions BX11, BX12, BX13, BX14 and BX15 with respect to the reference axis AX1, and respectively transmit the plural signals S41, S42, S43, S44 and S45 in response to the driving signal S3. Alternatively, the plural signal transmitters 4221, 4222, 4223, 4224 and 4225 transmit the plural signals S41, S42, S43, S44 and S45 in response to the plural signals S31, S32, S33, S34 and S35, respectively.

The plural signals S41, S42, S43, S44 and S45 may be light frequency signals, audio signals, electromagnetic signals or a combination thereof. The plural signal transmitters 4221, 4222, 4223, 4224 and 4225 may be light emitting diodes, laser sources, infrared sources, acoustic sources, supersonic wave sources, electromagnetic sources, radio frequency sources or a combination thereof. In an embodiment, the plural signal transmitters 4221, 4222, 4223, 4224 and 4225 may be distributed over either a whole or a portion of the remote control apparatus 31; e.g., they are disposed over the terminal portion EP1.

The signal S2 produced by the determining device 41 may include the message U1, e.g. a controlling message. The message U1 may include the control code CD1 for controlling the controlled apparatus 32. The remote control apparatus 31 communicates the control code CD1 to the controlled apparatus 32 through the plural signals S41, S42, S43, S44 and S45, wherein each of the plural signals S41, S42, S43, S44 and S45 includes the message U1, i.e. includes the control code CD1. The driving signal S3 may also include the message U1. The remote control apparatus 31 may be compatible with a touch type remote controller (not shown) controlling the controlled apparatus 32, wherein the touch type remote controller includes a push button having a function. In an embodiment, the motion MT1 of the remote control apparatus 31 corresponds to the function of the push button of the touch type remote controller.

In an embodiment based on FIG. 1, the remote control apparatus 31 may be a secure remote controller securely transmitting the control code CD1 to the controlled apparatus 32 when the remote control apparatus 31 has a large angular displacement. The remote control apparatus 31 may include the determining device 41 and the signaling unit 42. The determining device 41 generates the message U1, e.g. a controlling message. The signaling unit 42 transmits the message U1 in the plural transmitting directions DR11, DR12, DR13, DR14 and DR15. In an embodiment, the remote control apparatus 31 omnidirectionally transmits the message U1.

In an embodiment, the determining device 41 generates the message U1 in response to the motion MT1 of the remote control apparatus 31. The signaling unit 42 may include the plural signal transmitters 4221, 4222, 4223, 4224 and 4225 each of which transmits the message U1. In an embodiment, the plural signal transmitters 4221, 4222, 4223, 4224 and 4225 respectively transmit the plural signals S41, S42, S43, S44 and S45, e.g. being plural control signals, each of which carries the message U1.

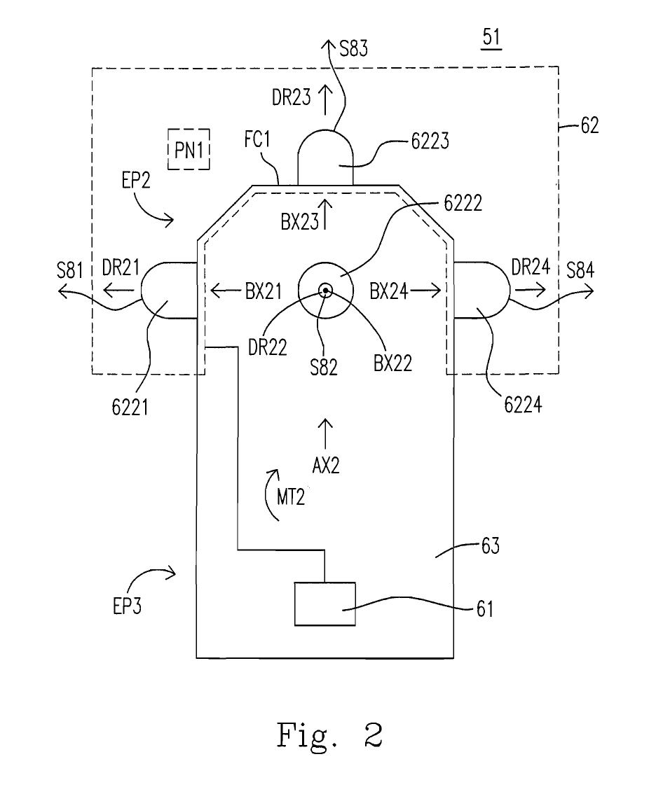

Please refer to FIG. 2, which is a schematic diagram showing the remote control apparatus 51 according to the second embodiment of the present invention. As shown, the remote control apparatus 51 includes the determining device 61, the signaling unit 62 and the shell structure 63. The signaling unit 62 is electrically coupled to the determining device 61. The shell structure 63 is used to fix the determining device 61 and the signaling unit 62, and includes the terminal portion EP2 and the held portion EP3.

The shell structure 63 has the reference axis AX2, and the signaling unit 62 includes the plural signal transmitters 6221, 6222, 6223 and 6224. The plural signal transmitters 6221, 6222, 6223 and 6224 are fixed to the terminal portion EP2 of the shell structure 63 respectively in the plural principal directions BX21, BX22, BX23 and BX24 with respect to the reference axis AX2. In an embodiment, the plural signal transmitters 6221, 6222, 6223 and 6224 may be fixed in radial directions to the surface portion of the terminal portion EP2 of the shell structure 63. In an embodiment, the two transmitting directions DR21 and DR23 of the plural transmitting directions DR21, DR22, DR23 and DR24 forms a plane PN1 being in one of being intersecting with the remote control apparatus 51 and being skew with respect to a surface FC1 of the remote control apparatus 51.

The remote control apparatus 51 has the motion MT2, and utilizes the plural signal transmitters 6221, 6222, 6223 and 6224 to respectively transmit the plural signals S81, S82, S83 and S84 associated with the motion MT2, wherein the plural signals S81, S82, S83 and S84 respectively have the plural transmitting directions DR21, DR22, DR23 and DR24. In an embodiment, the plural signals S81, S82, S83 and S84 respectively have the plural strongest transmitting directions to correspondingly transmit the energies of the plural signals S81, S82, S83 and S84, and the plural transmitting directions DR21, DR22, DR23 and DR24 are respectively directed to the plural strongest transmitting direction.

Please refer to FIG. 1 to describe a remote control method for controlling the controlled apparatus 32 according to the present invention. The remote control method includes the following steps: the signal S2 is produced in response to the motion MT1; and the plural associated signals S41, S42, S43, S44 and S45 are transmitted in response to the signal S2, wherein each of the plural signals S41, S42, S43, S44 and S45 has a respective transmitting direction. In an embodiment, the plural signals S41, S42, S43, S44 and S45 may be infrared signals, light frequency signals, electromagnetic signals, supersonic wave signals, radio frequency signals or a combination thereof. In another embodiment, a secure remote controlling method is provided and includes the following steps: a message U1, e.g. a controlling message is generated; and the message U1 is transmitted in a first direction, e.g. DR11, and a second direction, e.g. DR13.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A remote control apparatus having a motion, comprising:
a determining device producing a first signal in response to the motion; and
a signaling unit transmitting a plurality of signals associated with the first signal, wherein each of the plurality of signals has a respective transmitting direction.

2. A remote control apparatus according to claim 1, wherein at least one of the plurality of signals is transmitted by the signaling unit.

3. A remote control apparatus according to claim 1, wherein the determining device comprises:
a sensing unit sensing the motion to produce a second signal; and
a processing unit producing the first signal in response to the second signal.

4. A remote control apparatus according to claim 3, wherein the sensing unit comprises:
a first unit sensing the motion for producing the second signal, and including at least one selected from a group consisting of a single gyroscope, an accelerometer and a magnetometer.

5. A remote control apparatus according to claim 1, wherein the plurality of signals comprise ones selected from a group consisting of light frequency signals, audio signals, electromagnetic signals and a combination thereof.

6. A remote control apparatus according to claim 1, further having a reference axis, wherein the signaling unit comprises:
a driving circuit producing a driving signal in response to the first signal; and
a plurality of signal transmitters having a plurality of principal directions with respect to the reference axis, and transmitting the plurality of signals in response to the driving signal.

7. A remote control apparatus according to claim 6, wherein the plurality of signal transmitters are ones selected from a group consisting of light emitting diodes, laser sources, infrared sources, acoustic sources, supersonic wave sources, electromagnetic sources, radio frequency sources and a combination thereof.

8. A remote control apparatus according to claim 6, wherein the plurality of signal transmitters are distributed over one of a whole and a first portion of the remote control apparatus.

9. A remote control apparatus according to claim 8, wherein the first portion is a terminal portion.

10. A remote control apparatus according to claim 1, wherein the first signal includes a control code for controlling a controlled apparatus, and the control code is transmitted by the plurality of signals.

11. A remote control apparatus according to claim 10, being compatible with a touch type remote controller controlling the controlled apparatus.

12. A remote control apparatus according to claim 11, wherein the touch type remote controller includes a push button having a function, and the motion corresponds to the function of the push button.

13. A secure remote controller comprising:
a determining device generating a message; and
a signaling unit transmitting the message in a first direction and a second direction.

14. A controller according to claim 13 wherein:
the signaling unit further transmitting a first control signal and a second control signal respectively in the first direction and the second direction; and
each of the first and the second control signals carries the message.

15. A controller according to claim 13 wherein the determining device generates the message in response to a motion of the secure remote controller.

16. A controller according to claim 13 wherein the first and the second directions forms a plane being in one of being intersecting with the secure remote controller and being skew with respect to a surface of the secure remote controller.

17. A controller according to claim 13, wherein:
the signaling unit comprising a plurality of signal transmitters each of which transmits a respective control signal in a specific direction; and
the respective control signal carries the message.

18. A secure remote controlling method comprising steps of:
generating a controlling message; and
transmitting the controlling message in a first direction and a second direction.

19. A method according to claim 18 further comprising a step of transmitting a first control signal and a second control signal respectively in the first direction and the second direction, wherein each of the first and the second control signals carries the controlling message.

20. A method according to claim 18 wherein the transmitting step omnidirectionally transmits the controlling message.
